(19) United States
(12) Patent Application Publication
(10) Pub. No.: US 2006/0150795 A1
(43) Pub. Date: Jul. 13, 2006

(54) Punching apparatus and punching die used therefor

(75) Inventors: Masanori Mochizuki, Yao-shi (JP); Yusuke Fujii, Yao-shi (JP)

Correspondence Address: FITCH, EVEN, TABIN & FLANNERY, P. O. BOX 65973, WASHINGTON, DC, 20035, US

(73) Assignee: Isel Co., Ltd., Yao-shi (JP)

(21) Appl. No.: 11/329,208

(22) Filed: Jan. 11, 2006

(30) Foreign Application Priority Data
Jan. 11, 2005 (JP) 2005-4030

(51) Int. Cl. B26D 1/12; B26F 1/14

(52) U.S. Cl. 83/669; 83/684

(57) ABSTRACT

In a punching apparatus comprising: a punching station A for punching a large number of sheet products by a punching die 20 from a long material sheet 1 which is transferred in a horizontal direction; and a take-out station for taking out the sheet product punched by the punching die 20, wherein the punching die 20 has a structure that a blade portion of a tip end peripheral edge of a vertically penetrating die hole is brought into contact with the material sheet 1 under pressure, thereby sequentially punching the sheet products from the material sheet 1 and accommodating the sheet products in the die hole in a laminated state, and the take-out station includes an extrusion pusher for pushing out the sheet products which are accommodated in the laminated state from the die hole 28, the punching die is disposed below a transfer region of the material sheet to prevent the sheet product from falling onto the material sheet 1 from the die hole.

### BACKGROUND OF THE INVENTION

1. Field of the Invention

The present invention relates to a punching apparatus capable of smoothly punching a sheet and the like.

2. Disclosure of the Prior Art

As an apparatus for punching a sheet and the like such as a lid of a receptacle of a convenience or instant cup noodle, and a cap seal for sealing a bottle of an instant coffee, there is known a structure shown in FIGS. 9 and 10.

As shown in FIG. 9, a punching die 20 and a table 10 are vertically opposed to each other. An endless belt 13 is wound around a drive roller 11 and a driven roller 12, and runs along an upper surface of the table 10.

The punching die 20 includes a base block 21 and cylindrical blades 202 projecting downward from the base block 21. The base block 21 reciprocates in the widthwise direction of the endless belt 13 along a pair of side rails 24 and 24 arranged in parallel with each other on a lower surface of a vertically moving plate 23. The vertically moving plate 23 is guided by a plurality of guide posts 22. A portion where the vertically opposed punching die 20 and table 10 are disposed corresponds to a punching station A which will be explained later.

FIG. 10 is an explanatory diagram of a take-out station B which upwardly pushes, from the punching die 20, laminated sheet products 90 which were punched in the cylindrical blades 202 of the punching die 20 from a material sheet 1.

The take-out station B is provided at a portion of the punching apparatus deviated in the widthwise direction (direction perpendicular to a sheet surface of FIG. 9) of the endless belt 13 from the punching station A. The punching die 20 is guided by the side rails 24 and 24 which support the base block 21, and reciprocates between the take-out station B and the punching station A. An extrusion pusher 3 is provided below the take-out station B. Rods 3a on a tip end of the extrusion pusher 3 are pushed into the cylindrical blade 202 from below. The take-out station B is provided with a transfer pusher 32 for transferring laminated sheet products 90 pushed onto the base block 21 from the cylindrical blade 202 onto a product taking-out conveyer 26 by the rods 3a.

The operation of the conventional punching apparatus will be explained next.

As shown in FIG. 9, the material sheet 1 is placed on the endless belt 13 upstream (right side in FIG. 9) of the punching station A and then, if the punching operation is started, the endless belt 13 intermittently runs, and the material sheet 1 placed on the endless belt 13 is intermittently sent to the punching station A. When the endless belt 13 stops, the vertically moving plate 23 is lowered together with the punching die 20, and the material sheet 1 is sandwiched between the cylindrical blades 202 and the table 10 under pressure. With this, the sheet products 90 punched from the material sheet 1 are accommodated in the cylindrical blades 202. If the punching operation is repeated, the same number of sheet products 90 as that of the punching operations are accommodated and held in the cylindrical blades 202 in a laminated state.

Next, the punching die 20 is moved to the take-out station B along the side rails 24 and 24. Then, when the rods 3a on the tip end of the extrusion pusher 3 are pushed into the cylindrical blades 202, the laminated sheet products 90 accommodated in the cylindrical blades 202 are pushed up to the base block 21 by the rod 3a. Next, the transfer pusher 32 operates, and the sheet products 90 are transferred onto the product taking-out conveyer 26 and transferred to a next step.

According to the conventional technique, the predetermined number of sheet products 90 can be taken out from the cylindrical blades 202 in the laminated state. This eliminates a special counting operation for counting sheet products 90 which are punched one sheet by one sheet on the packaging basis, and eliminates an operation for laminating the sheet products 90 which are punched one sheet by one sheet. Therefore, working efficiency is excellent.

According to the conventional technique, however, there is a problem that the lowermost sheet product 90 accommodated in the cylindrical blade 202 accommodated in the cylindrical blade 202 is prone to drop below the cylindrical blade 202, and smooth punching operation is hindered.

This problem will be explained in more detail.

According to the conventional technique, the material sheet 1 is simply punched by the punching die 20 from above. Thus, the lowermost sheet product 90 accommodated in the cylindrical blades 202 in the laminated state is tightly fitted into an opening in a lower end of the cylindrical blade 202, thereby preventing the sheet product 90 from dropping. That is, the lowermost sheet product 90 is substantially flush with the opening in the lower end of the cylindrical blade 202 and in this state, the lowermost sheet product 90 is prone to drop downward.

Thus, if impact or vibration caused at the time of the punching operation is applied to the sheet products 90 in the cylindrical blade 202, the lowermost sheet product 90 drops form the cylindrical blade 202, the dropped sheet products 90 are scattered on an upper surface (surface to be punched) of the material sheet 1 and thus, the punching operation does not smoothly proceed.

Especially, there is a tendency that outer peripheral edges of the thin and soft sheet products 90 are curled and the entire sheet products 90 are shrunk and thus, it is difficult to hold the sheet products 90 in the cylindrical blade 202, the sheet products 90 drop downward and the smooth punching operation is prone to be hindered.

### SUMMARY OF THE INVENTION

In a punching apparatus comprising: a punching station A for punching a large number of sheet products 90 by a punching die 20 from a long material sheet 1 which is transferred in a horizontal direction; and a take-out station B for taking out the sheet product 90 punched by the punching die 20, wherein the punching die 20 has a structure that a blade portion 202a of a tip end peripheral edge of a vertically penetrating die hole 28 is brought into contact with the material sheet 1 under pressure, thereby sequentially punching the sheet products 90 from the material sheet 1 and accommodating the sheet products 90 in the die hole 28 in a laminated state, and the take-out station B includes an extrusion pusher 3 for pushing out the sheet products 90 which are accommodated in the laminated state from the die hole 28, it is a first object of the present invention to prevent the sheet product 90 from falling onto the material sheet 1 from the die hole 28, thereby making it possible to carry out a punching operation smoothly.

Technical means devised to achieve the first object is that the punching die 20 is disposed below a transfer region of the material sheet 1.

The above technical means is effected as follows.

Since the punching die 20 is disposed below a transfer region of the material sheet 1, a newly punched sheet product 90 is held in the vicinity of the upper end opening of the die hole 28, and the sheet products 90 are accommodated in the lower die hole 28 in the laminated state. Thus, unlike the conventional technique, the newly punched sheet product 90 is not held in the lower end opening of the die hole 28, and even when vibration or the like caused when punching the sheet is applied, there is no fear that the sheet product 90 falls onto the material sheet 1.

Since the present invention has the above-described structure, the following effect can be exhibited.

Since a newly punched sheet product 90 is held in the vicinity of the upper end opening of the die hole 28, unlike the conventional technique, the newly punched sheet product 90 is not held in the lower end opening of the die hole 28, and even when vibration or the like caused when punching the sheet is applied, there is no fear that the sheet product 90 falls onto the material sheet 1.

To achieve the same object, in the punching station A, a pressing pusher 27 for pushing the punched sheet product 90 into the die hole 28 is provided at a position opposed to the punching die 20 from above. The punched sheet product 90 can be pushed into the die hole 28 by the pressing pusher 27. Thus, it is possible to reliably prevent a case in which the uppermost sheet product 90 escapes from the upper end opening of the die hole 28 to outside.

If the punching die 20 is vertically driven by drive means, the punching die 20 after it punched the sheet product 90 is lowered. Thus, the peripheral edge of a punched hole of the sheet product 90 formed in the punching residue (hole formed by punching of the sheet product 90) is not caught in the blade portion 202a of the punching die 20, and the punching residue can smoothly be transferred.

Further, the punching apparatus further comprises: an air dancer mechanism for applying tension toward a downstream side of a long punching residue punched in the punching station A in the transfer direction, and a punching residue removing station D for reeling up the punching residue downstream of the air dancer mechanism, and the air dancer mechanism includes a vertical duct whose upper portion is opened for accommodating a U-shaped curved region formed by hanging a portion of the long punching residue downward, a covering member which is in contact with an upper surface of the U-shaped curved region and which has such a size as to cover a punched hole of the sheet product 90 remaining in the punching residue, and a suction fan for downwardly sucking interior of the vertical duct. With this, suction force of the suction fan is applied to the covering member through the punched hole (hole formed by punching the sheet product 90) of the sheet product 90 remaining in the punching residue. Thus, even when the suction force caused by the suction fan is not easily applied because the punched hole of the sheet product 90 is formed in the punching residue, the punching residue is pulled downward through the covering member reliably and thus, the tension is reliably applied to the punching residue.

It is a second object of the present invention to provide a die that can be employed to achieve the above object.

Technical means devised to achieve the object is that, in a punching die for bringing a blade portion 202a of an upper end peripheral edge of a vertically penetrating die hole 28 into contact with a material sheet 1 under pressure, thereby punching a sheet product 90 from the material sheet 1 into the die hole 28, an inner periphery of the blade portion 202a is formed into a tapered surface whose diameter is increased upwardly.

According to this technical means, the peripheral edge of the punched sheet product 90 is guided by the inner periphery of the blade portion 202a which is formed into the tapered surface whose diameter is increased upwardly and is forcibly press fitted into the die hole 28. Thus, the peripheral edge of the sheet product 90 is brought into contact with the inner periphery of the die hole 28 under pressure, the friction force is increased, and the sheet products 90 are more stably accommodated and held in the die hole 28.

To achieve the same object as the second object, in a punching die for bringing a blade portion 202a of an upper end peripheral edge of a vertically penetrating die hole 28 into contact with a material sheet 1 under pressure, thereby punching a sheet product 90 from the material sheet 1 into the die hole 28, an inner peripheral wall of the die hole 28 is provided with a plurality of elastic projecting members at distances from one another in a circumferential direction, each elastic projecting member being engaged with a peripheral edge of the sheet product 90 from below. With this, the elastic projecting member is engaged with the peripheral edge of the punched sheet product 90 from below and thus, the sheet products 90 are more stably accommodated and held in the die hole 28.

In a punching die for bringing a blade portion 202a of an upper end peripheral edge of a vertically penetrating die hole 28 into contact with a material sheet 1 under pressure, thereby punching a sheet product 90 from the material sheet 1 into the die hole 28, an inner peripheral wall of the die hole 28 is provided with a plurality of elastic projecting members at distances from one another in a vertical direction, each elastic projecting member being engaged with a peripheral edge of the sheet product 90 from below. Also with this, the elastic projecting member is engaged with the peripheral edge of the punched sheet product 90 from below and thus, the sheet products 90 are more stably accommodated and held in the die hole 28.

In a punching die for bringing a blade portion 202a of an upper end peripheral edge of a vertically penetrating die hole 28 into contact with a material sheet 1 under pressure, thereby punching a sheet product 90 from the material sheet 1 into the die hole 28, an inner peripheral wall of the die hole 28 is provided with a plurality of elastic projecting members at distances from one another in a circumferential direction and a vertical direction, each elastic projecting member being engaged with a peripheral edge of the sheet product 90 from below. With this, the sheet products 90 are more stably accommodated and held in the die hole 28.

In the punching die, the elastic projecting members disposed at distances from one another in an axial direction are disposed on a base block 70 at distances from one another in the vertical direction, the base block 70 being fitted into a fitting groove which is formed in an inner peripheral wall of the die hole 28 and extends in the vertical direction. With this, since the assembly of the base block 70 and the elastic projecting member can be integrally formed of resin or the like, it is possible to select material in accordance with a purpose.

The punching die may further comprise a cylindrical blade 202 whose inner periphery is the die hole 28, and a blade holder 201 for holding the cylindrical blade 202, and the blade holder 201 is formed with a through hole comprising a large-diameter hole 203 which is tightly fitted over the cylindrical blade 202 in a state in which a blade portion 202 of an upper end of the cylindrical blade 202 is exposed outside, and a small-diameter hole 204 which is coaxial with the large-diameter hole 203, and in a state in which the large-diameter hole 203 is tightly fitted over the cylindrical blade 202, a lower end of the cylindrical blade 202 abuts against a step at a boundary whose inner diameter is varied from the large-diameter hole 203 to the small-diameter hole 204. With this, if the cylindrical blade 202 is made of hard metal material, it is possible to obtain a cylindrical blade 202 having excellent durability. Since the blade holder 201 can be made of material having low hardness such as aluminum alloy which can be machined easily, the manufacturing efficiency of the punching die is enhanced. In the punching die, if the cylindrical blade 202 is the Thomson hollow blade, the cylindrical blade 202 can be manufactured only by bending a band-like blade into a cylindrical shape. Thus, unlike the case where a carving hollow blade is employed as the cylindrical blade 202, it is unnecessary to cut the blade tip using an end mill, and it is easy to manufacture the blade.

In each of the punching dies, the blade portion 202a of the punching die sandwiches the material sheet 1 in cooperation with an elastic annular blade receiver 206 under pressure. The blade receiver 206 is detachably attached to a fixing wall. Since the elastic annular blade receiver 206 is provided only in a region required for punching the material sheet 1, it is possible to manufacture the blade receiver 206 using less material.

Other objects, features, aspects and advantages of the invention will become more apparent from the following detailed description of an embodiment with reference to the accompanying drawings and appended claims.

### BRIEF DESCRIPTION OF THE DRAWINGS

FIG. 1 is a schematic vertical sectional view of a punching apparatus according to an embodiment of the present invention;

FIG. 2 is a vertical sectional view of a punching station A and a take-out station B of the punching apparatus according to the embodiment of the present invention;

FIG. 3 is a schematic transverse sectional view of the punching apparatus according to the embodiment of the present invention;

FIG. 4 is a bottom view of a material sheet 1;

FIG. 5 is an explanatory diagram of a relation between a vertically moving plate 60 and guide posts 35 and 35;

FIG. 6 is an enlarged sectional view of a portion where a punching die 20 is disposed;

FIG. 7 is a perspective view of a sheet holder 7;

FIG. 8 is a perspective view of loading portions of anchor nuts 203n;

FIG. 9 is an explanatory view of a conventional technique; and

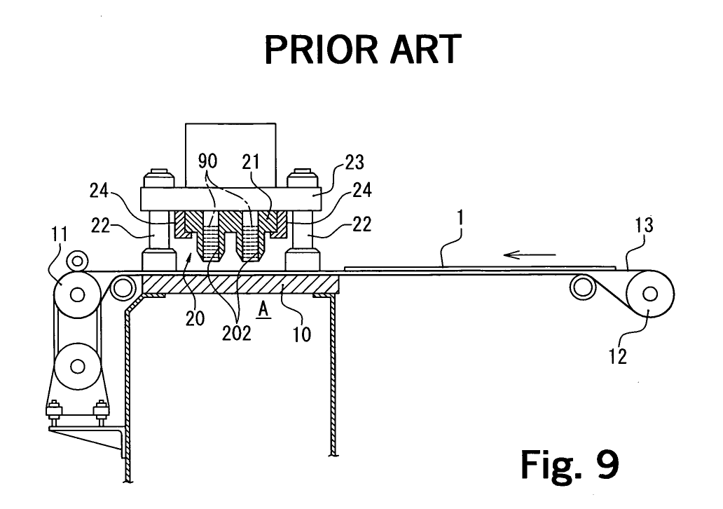

FIG. 10 is an explanatory view of the conventional technique.

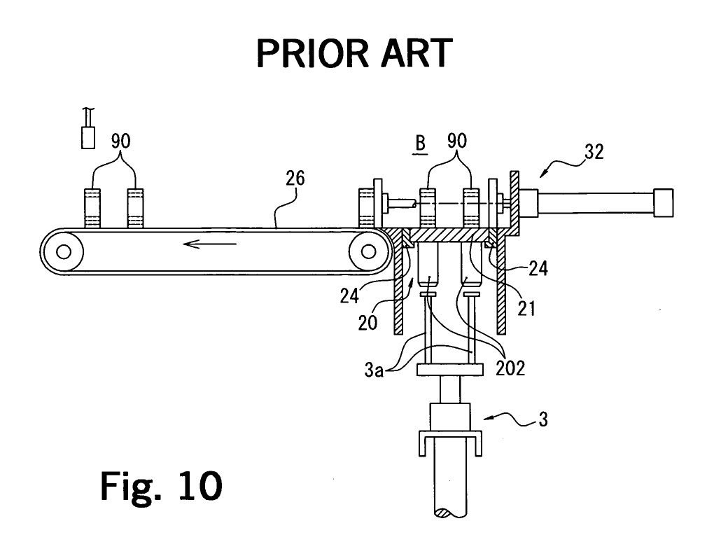

### DETAILED DESCRIPTION OF THE EMBODIMENT

Best modes for carrying out the present invention will be explained below with reference to the attached drawings.

Entire Structure

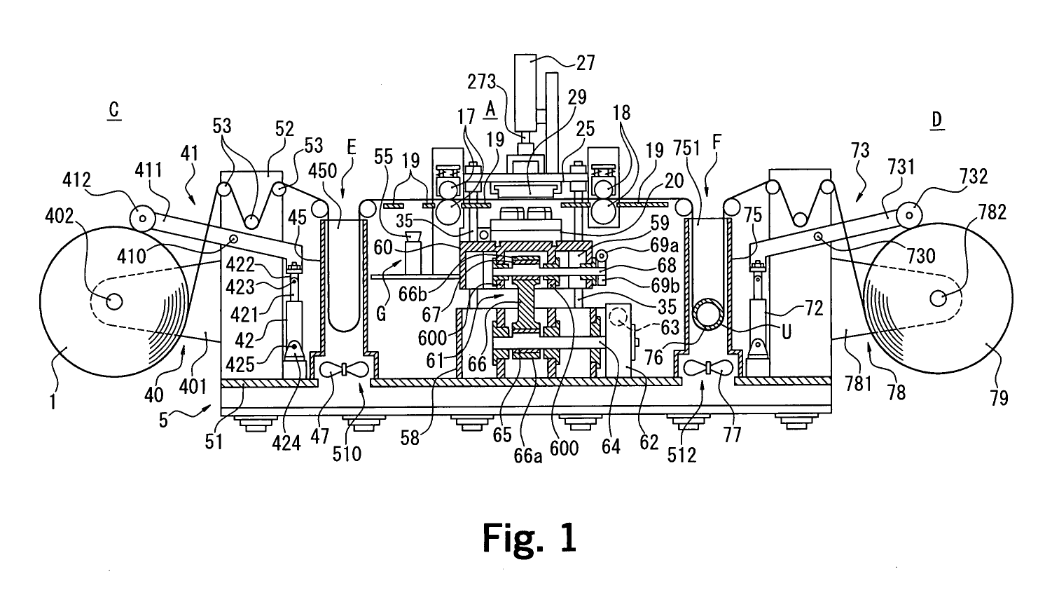

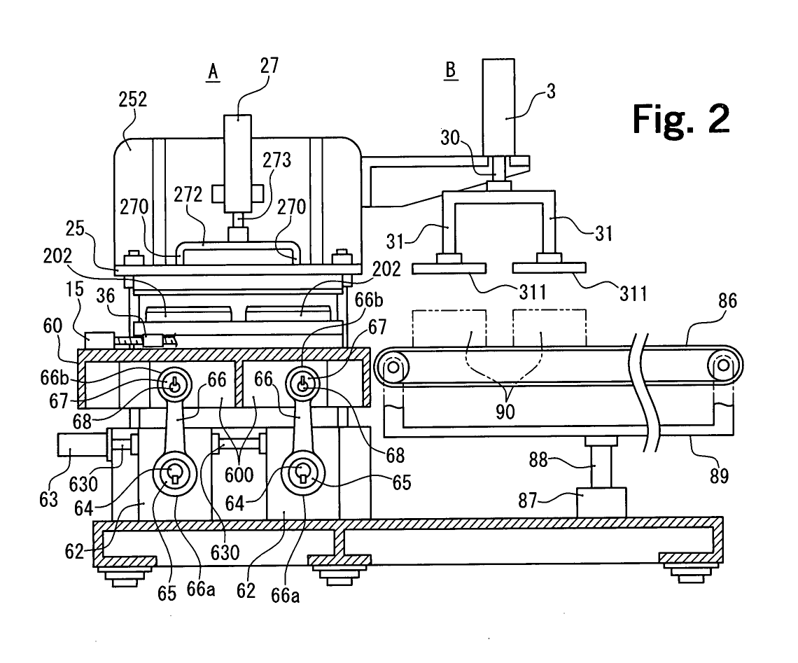

As shown in FIG. 1, a punching apparatus according to an embodiment of the present invention includes a material supply station C for unreeling a material sheet 1 which is reeled up in a form of a roll, a punching station A for punching sheet products 90 from the material sheet 1, a take-out station B (see FIG. 2) for taking out the punched sheet products 90 on the side of the punching station A, and a punching residue removing station D for reeling up punching residues generated when the sheet products 90 are punched. Air dancer mechanisms E and F for constantly adjusting the tension of the material sheet 1 are provided among the punching station A, the material supply station C and the punching residue removing station D.

Details of the various portions will be explained below.

Material Supply Station C

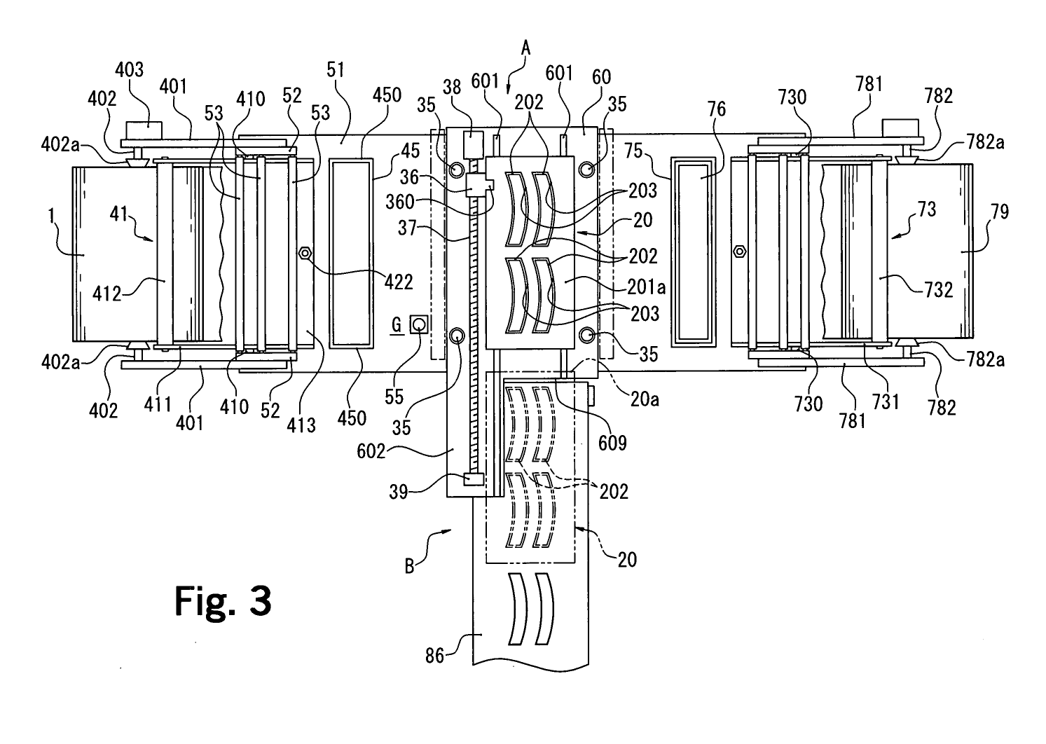

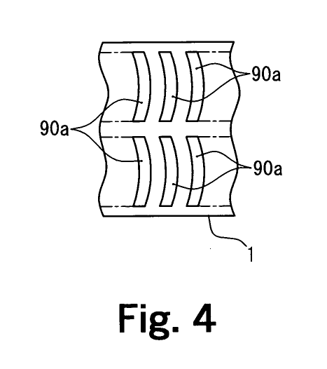

The material supply station C is structured as shown in FIGS. 1 and 3 (an intermediate portion of the material sheet 1 is not shown in FIG. 3). The material supply station C includes a roll support mechanism 40 for rotatably supporting the material sheet 1 which is reeled up in the form of the roll, and a sheet press mechanism 41. The material sheet 1 which is reeled up in the form of the roll is formed with a large number of punching regions 90a on which designs or characters are printed as shown in FIG. 4. Such designs or characters will be printed on the sheet products 90. In this embodiment, the material sheet 1 is supplied to the punching station A in such a posture that the printing surface comes lower side.

Roll Support Mechanism 40

The roll support mechanism 40 includes support arms 401 and 401 horizontally projecting from a pair of sidewalls 52 and 52 which stand from opposite sides of a base 51 of an apparatus main body 5. Conical heads 402a and 402a of roll shafts 402 and 402 projecting from the support arms 401 and 401 such as to be opposed to each other are press-fitted into center holes of the roll-shaped material sheet 1 from both sides. One of the roll shaft 402 is rotated by a sending motor 403 and with this, the material sheet 1 is reeled out.

Sheet Press Mechanism 41

The sheet press mechanism 41 is provided with a rotatable press roll 412 which extends between rocking tip ends of rock arms 411 and 411 which are vertically rotatably supported at the sidewalls 52 and 52 by support shafts 410 and 410. A connecting plate 413 for mutually connecting base ends of the rock arms 411 and 411 is connected to a tip end of a piston rod 421 of an air cylinder 42 through a connecting rod 422. The piston rod 421 and the connecting rod 422 are rotatably connected to each other through a coupling pin 423. A lower end of the air cylinder 42 is rotatably connected to a cylinder support 424 by an anchor pin 425. The air cylinder 42 is contracted when the material sheet 1 which is reeled up in the form of the roll is mounted on the roll support mechanism 40 to lift up a press roll 412 on a tip end of the rock arm 411.

Air Dancer Mechanism E

Provided downstream of the material sheet 1 in the transfer direction with respect to the material supply station Care guide rollers 53, 53 and 53 extending between the sidewalls 52 and 52. The air dancer mechanism E is provided further downstream of the guide rollers 53, 53 and 53. The air dancer mechanism E includes a rectangular cylindrical vertical duct 45, and a suction fan 47 for drawing inside air downward.

Upper and lower ends of the vertical duct 45 are opened, and its plane is formed into a rectangular shape which is long in the widthwise direction of the material sheet 1.

The suction fan 47 is provided below the vertical duct 45. The base 51 of the apparatus main body 5 is provided with a vent hole 510 which is opposed to the suction fan 47.

Image-Capturing Station G

A camera 55 such as a CCD camera is disposed in an image-capturing station G disposed downward of the air dancer mechanism E in the transfer direction of the material sheet 1.

The camera 55 has a function of capturing an image of reference marks disposed in the vicinity of punching regions 90a printed on the material sheet 1. A transfer control apparatus (not shown) controls later-described sending rollers 17 and 18 so that the transfer and stop of the material sheet 1 are repeated whenever the camera 55 detects the reference mark. When the transfer of the material sheet 1 is stopped, the punching regions 90a and 90a in the material sheet 1 shown in FIG. 4 (regions to be punched as the sheet products 90 and 90) are opposed to cylindrical blades 202 of the punching die 20 of the later-described punching station A from above.

Punching Station A

The punching station A located downward of the image-capturing station G in the transfer direction of the material sheet 1 has a structure shown in FIGS. 1 to 3.

Entire Structure

The punching station A includes a vertically moving plate 60 which is vertically driven by a crank mechanism 61 corresponding to drive means which is a matter of the invention in claims 3 and 4, the punching die 20 which is set on the vertically moving plate 60, and a pressing pusher 27 provided on the fixing plate 25 which holds a die receiver 29 located above the punching die 20. The pressing pusher 27 pushes the punched sheet product 90 into the cylindrical blade 202 of the punching die 20.

Crank Mechanism 61

As shown in FIGS. 1 and 2, the crank mechanism 61 which vertically drives the vertically moving plate 60 includes an input side auxiliary shaft 65 which is eccentrically fitted to a rotation shaft 64 of a speed reducer 62 which reduces the speed of rotation of the punching motor 63 (rotation of motor shaft 630), and a connecting rod 66 having a lower end boss 66a which is rotatably fitted over the input side auxiliary shaft 65. An upper end boss 66b of the connecting rod 66 is rotatably fitted over an output side auxiliary shaft 67, and a blade height adjusting shaft 68 which rotatably penetrates trailing walls 600 and 600 of the vertically moving plate 60 eccentrically penetrates the output side auxiliary shaft 67.

Therefore, the rotation of the motor shaft 630 caused by operation of the punching motor 63 is transmitted from the speed reducer 62 to the vertically moving plate 60 through the rotation shaft 64, the input side auxiliary shaft 65, the connecting rod 66, the output side auxiliary shaft 67 and the blade height adjusting shaft 68 in this order, and the punching die 20 disposed on the vertically moving plate 60 is vertically moved.

The blade height adjusting shaft 68 is provided at its one end with a worm wheel 69b which meshes with a worm 69a rotated by a blade height adjusting motor (not shown). The rotation of the blade height adjusting motor is transmitted from the worm 69a to the blade height adjusting shaft 68 through the wormwheel 69b. With this, the height of the vertically moving plate 60 is finely adjusted by a fitting relation between the blade height adjusting shaft 68, the output side auxiliary shaft 67 and the connecting rod 66.

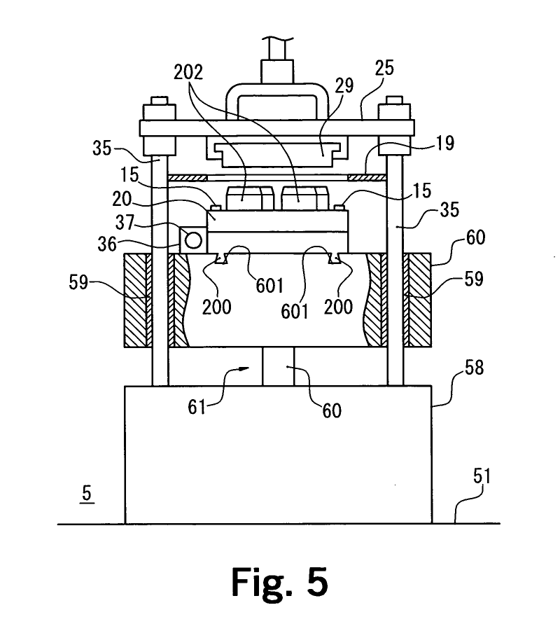

As shown in FIGS. 1, 3 and 5, the vertically moving plate 60 is guided by four guide posts 35 and 35 which stand from a surrounding wall 58, and is moved vertically. The surrounding wall 58 surrounds a lower portion of the crank mechanism 61 provided on the base 51 of the apparatus main body 5. Thus, the guide posts 35 and 35 standing from the surrounding wall 58 penetrate the vertically moving plate 60 through direct bearings 59 and 59. A fixing plate 25 for mounting the die receiver 29 located above the punching die 20 is fixed to an upper end of the guide posts 35 and 35.

Punching Die 20

The punching die 20 disposed below the transfer region of the material sheet 1 is mounted on the upper surface of the vertically moving plate 60 such that the punching die 20 can slide in the widthwise direction of the material sheet 1.

Thus, the upper surface of the vertically moving plate 60 is formed with dovetail grooves 601 and 601 which are in parallel to the widthwise direction. One of the dovetail grooves 601 and 601 is formed from the vertically moving plate 60 to a tip end of the rectangular extension arm 602 which projects toward the take-out station B. Dovetail members 200 and 200 projecting from a lower surface of the punching die 20 are slidably fitted into the dovetail grooves 601 and 601.

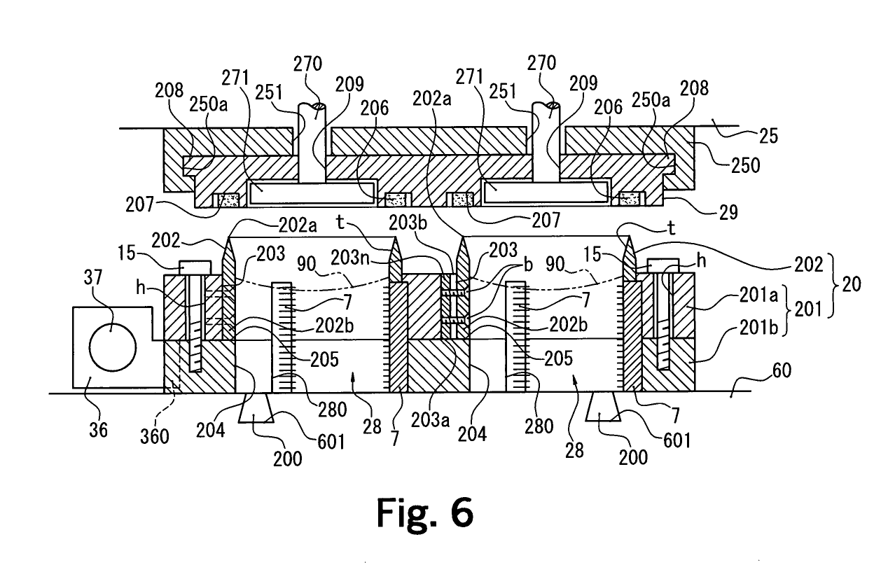

As shown in FIG. 6, the punching die 20 includes the cylindrical blade 202 and a blade holder 201. The blade holder 201 includes a blade cover 201a which is fitted over the cylindrical blade 202 and a slide block 201b located below the blade cover 201a.

In this embodiment, the cylindrical blade 202 is formed from a Thomson hollow blade. An inner periphery of a blade portion 202a on the upper end of the Thomson hollow blade is tapered into a tapered surface t whose diameter is increased upwardly. Therefore, a peripheral edge of the punched sheet product 90 is guided inward by the tapered surface t, and the sheet product 90 is forcibly press fitted into the cylindrical blade 202. Thus, friction between the peripheral edge of the sheet product 90 and an inner peripheral surface of the cylindrical blade 202 becomes high and the sheet product 90 is less prone to drop downward.

As shown in FIG. 3, large-diameter holes 203 are formed vertically in the blade cover 201a so that the four cylindrical blades 202 are tightly fitted into the large-diameter holes 203. As shown in FIG. 6, small-diameter holes 204 each having the same plane shape as the inner peripheral shape of the cylindrical blade 202 are vertically formed in the slide block 201b. A lower end 202b of the cylindrical blade 202 abuts against a step 205 at a boundary where an inner diameter is varied from the large-diameter hole 203 to the small-diameter hole 204. In this abutment state, a uniform cylindrical hole is formed by the cylindrical blade 202 and the inner peripheral surface of the small-diameter hole 204, and this cylindrical hole becomes a die hole 28 for punching the sheet product 90 from the material sheet 1. The inner diameter of the large-diameter hole 203 formed in the slide block 201b may be slightly larger than that of the cylindrical blade 202.

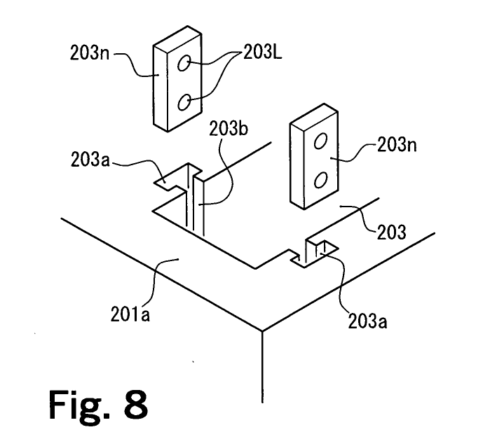

As shown in FIGS. 6 and 8, a vertical hole 203a into which a block-like anchor nut 203n is inserted is formed in the vicinity of the peripheral edge of the large-diameter hole 203 formed in the blade cover 201a. The vertical hole 203a is in communication with the large-diameter hole 203 through a slit 203b formed in the entire vertical region. If screws b and b penetrating the cylindrical blade 202 are threadedly inserted into female threads 203L and 203L of the anchor nut 203n shown in FIG. 8 (see FIG. 6), the cylindrical blade 202 is stabilized in the blade holder 201. Thus, even when a band-like blade is bent into a cylindrical shape to form the cylindrical blade 202, butting both ends of the band-like blade can reliably be prevented from falling out from the step 205.

With this, the cylindrical blade 202 and the blade holder 201 are formed as separate members. Thus, if the cylindrical blade 202 is made of hard metal material, the cylindrical blade 202 can be made as a blade having excellent durability. Further, the blade holder 201 can be made of low hardness material such as aluminum alloy which can easily be machined and thus, the producing efficiency of the punching die 20 is enhanced.

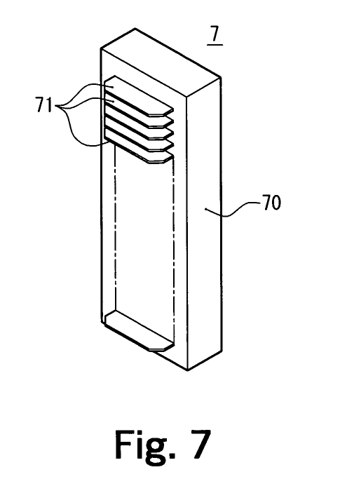

An inner peripheral wall of the die hole 28 is formed with fitting grooves 280 extending vertically such that the grooves are opened downward. The fitting grooves 280 are formed at predetermined pitches from one another in the circumferential direction, and the sheet holder 7 shown in FIG. 7 is fitted in each fitting groove 280.

The sheet holder 7 is a resin integrally molded member in which a large number of soft elastic fins 71 and 71 as elastic projecting members project from the rectangular parallelepiped base block 70 so as to align vertically, and the sheet holder 7 is formed by one injection molding. A preferable projecting amount of the elastic fins 71 and 71 is varied depending upon the size of the sheet product 90, but is set to such a value that the peripheral edge of the sheet product 90 is slightly engaged with the elastic fin.

Therefore, the peripheral edge of the sheet product 90 which is punched in the cylindrical blade 202 of the punching die 20 from the material sheet 1 engages with the elastic fins 71 and 71 and becomes difficult to drop downward.

The elastic projecting members are not limited to the elastic fins 71 and 71 shown in FIG. 7, and may be minute spherical projections.

As shown in FIG. 6, bolt insertion holes hand h vertically penetrate the blade cover 201a which constitutes the blade holder 201. Fixing bolts 15 and 15 inserted from the bolt insertion holes h and h are threadedly engaged with the slide block 201b and with this, the blade cover 201a and the slide block 201b are connected to each other.

As shown in FIGS. 3 and 6, an engaging projection 360 of a runner 36 threadedly engaged with sending screw 37 which is rotated by a sending motor 38 is engaged with the slide block 201b of the blade holder 201. A tip end of the sending screw 37 is supported by a rotation bearing 39 disposed on an end of an extension arm 602 projecting from the vertically moving plate 60. Thus, if the sending screw 37 rotates, the punching die 20 is guided by the dovetail grooves 601 and 601 and is moved. The punching die 20 which moves to the terminal end on the side of the take-out station B is placed on a base end straight region 609 which extends in the transfer direction of the material sheet 1 from a base end of the extension arm 602 of the vertically moving plate 60.

Die Receiver 29

As shown in FIG. 6, a lower surface of the die receiver 29 disposed above the punching die 20 is detachably provided with an elastic annular blade receiver 206 for sandwiching the material sheet 1 in cooperation with the cylindrical blade 202 under pressure. That is, the lower surface of the die receiver 29 which is a fixing wall as a specific item in the invention is formed with an annular groove 207 opposed to the blade portion 202a of the cylindrical blade 202, and the resin blade receiver 206 which has a size smaller than that of the annular groove 207 is fitted into the annular groove 207 such that the blade receiver 206 is forcibly opened. A resin blade receiver 206 which has a size larger than that of the annular groove 207 may be fitted into the annular groove 207 such that the blade receiver 206 is forcibly shrunk. Since the resin blade receiver 206 is provided only in a region required for punching the material sheet 1, there is an advantage that the blade receiver 206 can be produced with a small amount of material.

Engaging ribs 208 and 208 projecting from opposite ends of the die receiver 29 are engaged with engaging grooves 250a and 250a of the holder 250 fixed to a lower surface of the fixing plate 25 which holds the die receiver 29. With this, the die receiver 29 is held by the holder 250.

As shown in FIG. 6, a vertically moving shaft 270 is vertically movably inserted into through holes 209 and 251 respectively formed in the die receiver 29 and the fixing plate 25. The vertically moving shaft 270 is continuously formed on a pressing pusher 27 (see FIGS. 1 and 2) which pushes the punched sheet product 90 into the cylindrical blade 202. A press plate 271 for pushing the sheet product 90 is fixed to a lower end of the pressing pusher 27.

As shown in FIG. 2, an upper end of the vertically moving shaft 270 is connected to a piston rod 273 of the pressing pusher 27 (which is fixed to a vertical wall 252 of the fixing plate 25) through a horizontal member 272. Thus, if the piston rod 273 of the pressing pusher 27 advances or retreats, press plates 271 and 271 corresponding to the cylindrical blades 202 and 202 are moved upward or downward and with this, the punched sheet product 90 is pushed into the cylindrical blade 202. More specifically, the press plates 271 and 271 push the sheet products 90 to the blade portions 202a of the cylindrical blades 202 at positions lower than base end of the inner peripheral tapered surface t. This pushing distance is set to a value smaller than a pitch of the elastic fin 71. Therefore, even if the pressure in the die hole 28 becomes negative value when the punching die 20 is separated downward from the die receiver 29, the uppermost sheet product 90 in the punching die 20 is sucked upward and does not escape from the die.

An approach of the punching station A is provided with the sending rollers 17 and 18 for sending the material sheet 1 in a state where the material sheet 1 is sandwiched from front and back sides under pressure.

The material sheet 1 slides on the fixing table 19.

Take-Out Station B

As shown in FIGS. 2 and 3, the take-out station B disposed at a location deviated from the punching station A in the widthwise direction of the material sheet 1 includes a product taking-out conveyer 86, and the extrusion pusher 3 for dropping the sheet products 90 and 90 on the product taking-out conveyer 86 from the punching die 20.

Extrusion Pusher 3

As shown in FIG. 2, product press plates 311 and 311 of lower ends of the vertically moving shafts 31 and 31 which are continuously formed on the tip end of the piston rod 30 of the extrusion pusher 3 face above the product taking-out conveyer 86. If the vertically moving shafts 31 and 31 vertically move in association with advancing and retreating motions of the piston rod 30, the product press plates 311 and 311 drop the laminated sheet products 90 accommodated in the cylindrical blades 202 and 202 of the punching die 20 onto the product taking-out conveyer 86.

Product Taking-Out Conveyer 86

A transfer surface of the product taking-out conveyer 86 is set to the same height as that of the vertically moving plate 60 which is located at the bottom dead center.

The product taking-out conveyer 86 is vertically moved by a vertically moving cylinder 87. Thus, the product taking-out conveyer 86 is supported by a support arm 89 mounted on a tip end of the piston rod 88 of the vertically moving cylinder 87.

Therefore, when the sheet products 90 are dropped from the punching die 20, if the product taking-out conveyer 86 is lifted to the rising position by the vertically moving cylinder 87 and the sheet products 90 are dropped onto the product taking-out conveyer 86 by the extrusion pusher 3, the product taking-out conveyer 86 is lowered by the vertically moving cylinder 87 at the same time. If the product taking-out conveyer 86 runs in this lowered state, the laminated sheet products 90 are transferred to a next step.

Air Dancer Mechanism F

The air dancer mechanism F provided downstream of the punching station A in the transfer direction of the material sheet 1 includes a rectangular cylindrical vertical duct 75, a light cylindrical covering member 76 accommodated in the vertical duct 75 such that the covering member 76 can vertically move, and a suction fan 77 for sucking the covering member 76.

Upper and lower ends of the vertical duct 75 are opened, and its plane is formed into a rectangular shape which is long in the widthwise direction of the punching residue 79.

The covering member 76 is formed into a hollow cylindrical shape whose opposite ends are opened. The covering member 76 is made of resin to reduce its weight. The covering member 76 is disposed in a U-shaped curved region U of the punching residue 79 which is hanging in the vertical duct 75. The covering member 76 has such a size that a punched hole (hole made by punching the punching region 90a) of the sheet product 90 remaining in the punching residue 79 is covered. With this, if the covering member 76 is sucked by the suction fan 77, appropriate tension is applied to the punching residue 79. That is, since the punching residue 79 is formed with the punched hole of the sheet product 90, even when the suction force caused by the suction fan 77 is less prone to be applied, the punching residue 79 is reliably pulled downward through the covering member 76, tension can reliably be applied to the punching residue 79. An endless belt (obtained by forming an elastic sheet into an endless belt shape) having substantially the same width as that of an inner size of a long side of the vertical duct 75 can be employed as the covering member 76. If the covering member 76 comprises opaque endless belt, even if the material sheet 1 is transparent sheet, the punching residue 79 can smoothly reeled up by the residue removing station D. That is, when reflection light of beam emitted to the covering member 76 is detected through the transparent sheet and the reeling timing of the punching residue 79 is set, it is unnecessary to adjust the intensity of the beam or the amount of light by the transparency of the transparent sheet, and the punching residue 79 can be reeled up smoothly.

The suction fan 77 is disposed at a lower portion of the vertical duct 75, and a vent hole 512 opposed to the suction fan 77 is formed in the base 51 of the apparatus main body 5.

If the covering member 76 having substantially the same width (length in the axial direction if the duct is a hollow cylinder) as an inner side on the long side of the vertical duct 75 is employed, it becomes unnecessary to adjust the long side of the vertical duct 75 in accordance with the width of the material sheet 1.

Punching Residue Removing Station D

The punching residue removing station D provided downstream of the air dancer mechanism F in the transfer direction of the material sheet 1 has the same function and structure as those of the material supply station C. Thus, the punching residue removing station D has a rock arm 731 which rocks around a support shaft 730 and which is continuously provided at its opposite ends with a press roll 732 and an air cylinder 72, and a roll support mechanism 73 having a support arm 78 which rotatably supports a punching residue 79 reeled up in the form of a roll by the roll shaft 782.

Actual Operation

The actual operation of the punching apparatus will be explained next.

As shown in FIG. 1, the material sheet 1 which is reeled up in the form of the roll is mounted on roll shafts 402 and 402 in the material supply station C, an end of the material sheet 1 is pulled out, the end is wound around the guide rollers 53 and 53, inserted into the vertical duct 45, between the sending roller 17, between the punching die 20 and the die receiver 29, the lower side of the covering member 76 in the vertical duct 75, the roll shaft 782 of the support arm 78 in this order, and the preparation operation is completed.

Next, if an operation switch (not shown) is turned on, the sending motor 403 is rotated, and the material sheet 1 is intermittently transferred by the intermittent rotation of the sending rollers 17 and 18. The hollow cylindrical covering member 76 is sucked by rotation of the suction fans 47 and 77, and appropriate tension is applied to the material sheet 1.

If the camera 55 provided in the image-capturing station G detects “reference mark” printed on the material sheet 1, the sending rollers 17 and 18 are stopped, the punching regions 90a and 90a (see FIG. 4) in the material sheet 1 are opposed to the cylindrical blades 202 and 202 of the punching die 20 from above. Next, the crank mechanism 61 is operated by the rotation of the punching motor 63, and if the vertically moving plate 60 reaches the top dead center, the punching regions 90a and 90a are sandwiched between the die receiver 29 and the punching die 20 mounted on the vertically moving plate 60 under pressure and with this, the sheet product 90 is punched from the material sheet 1. At the same time, the piston rod 273 of the pressing pusher 27 advances, and the press plate 271 (see FIG. 6) of the lower end of the vertically moving shaft 270 connected to the piston rod 273 is lowered. With this, the punched sheet product 90 is pushed into the cylindrical blade 202 of the punching die 20 as described above.

Thereafter, if the vertically moving plate 60 is lowered, the piston rod 273 of the pressing pusher 27 is retreated at the same time, and the press plates 271 of the lower end of the vertically moving shaft 270 connected to the piston rod 273 is moved upward to the initial position.

According to the punching apparatus, after the material sheet 1 is punched, the punching die 20 on the vertically moving plate 60 is lowered. Thus, unlike the case where the punching die 20 is not vertically moved (when the punching die 20 is fixed and the die receiver 29 is vertically moved), even if the punching residue 79 (obtained by punching the sheet product 90 from the material sheet 1) is slightly bent downward, this portion is not caught in the upper end of the cylindrical blade 202 of the punching die 20, and the punching residue 79 can smoothly transferred toward the downstream.

Next, the material sheet 1 is transferred until the camera 55 detects the subsequent “reference mark”, the above operation is again carried out, and the sheet product 90 is punched.

If this punching operation is repeated predetermined times (e.g., the number of packaging unit), the punched sheet products 90 are accommodated in the die hole 28 of the punching die 20 in the laminated state.

Then, in a state where the vertically moving plate 60 is located at the bottom dead center, the sending motor 38 for sending the punching die 20 toward the take-out station B is operated to rotate the sending screw 37, and the runner 36 which is threadedly engaged with the sending screw 37 pulls the punching die 20 toward the take-out station B.

When the vertically moving plate 60 is at the bottom dead center, the vertically moving plate 60 and the transfer surface of the product taking-out conveyer 86 are flush with each other. Therefore, the punching die 20 pulled by the runner 36 runs on the vertically moving plate 60 as shown with the phantom line in FIG. 3, and the punching die 20 moves to a position above the product taking-out conveyer 86.

In this state, the product press plates 311 and 311 (driven by the extrusion pusher 3) face the cylindrical blades 202 and 202 from above. If the extrusion pusher 3 is operated to advance the piston rod 30, the product press plates 311 and 311 of the lower ends of the vertically moving shafts 31 and 31 push out the laminated sheet products 90 which are accommodated in the cylindrical blades 202 and 202 of the punching die 20 to locations above the product taking-out conveyer 86. At the same time, the piston rod 88 of the vertically moving cylinder 87 is retreated, and the sheet products 90 are taken out downward from the punching die 20. Then, the sheet products 90 are transferred to the downstream end 861 by the product taking-out conveyer 86, and are moved to a next packaging step.

The punching residue 79 after the sheet product 90 is punched from the material sheet 1 is reeled up in the punching residue removing station D through the air dancer mechanism F. At that time, since the punching residue 79 is formed with the large number of punched holes of the sheet product 90, if the covering member 76 of the air dancer mechanism F is not provided, the suction force of the punching residue 79 by the suction fan 77 becomes insufficient, and appropriate tension can not be applied to the covering member 76. According to this embodiment, since the punching residue 79 is pulled by the suction fan 77 through the covering member 76, appropriate tension can be applied to the punching residue 79.

Others

1. Although the sheet product 90 is punched by sandwiching the material sheet 1 by the punching die 20 and the die receiver 29 under pressure in this embodiment, the sheet product 90 may be punched by a male mold and a female mold which vertically moves below the male mold.

2. Although the cylindrical blades 202 are arranged in a matrix manner in a plain view in this embodiment, the cylindrical blades 202 may be arranged in a zigzag shape.

3. Although the cylindrical blade 202 is the Thomson blade in this embodiment, the cylindrical blade 202 may be a carving hollow blade.

4. An annular recess groove may be formed in an upper end surface (portion corresponding to the step 205) of the slide block 201b of the punching die 20 along the peripheral edge of the small-diameter hole 204, and the lower end of the cylindrical blade 202 may be inserted into the annular groove. With this, the lower end of the cylindrical blade 202 is fitted into the annular groove and is stabilized even if the lower screw b which fixes the cylindrical blade 202 shown in FIG. 6 is not provided.

5. The anchor nut 203n may be formed into a cylindrical shape, and the vertical hole 203a having a circular cross section for inserting the anchor nut 203n may be formed in the blade cover 201a.

6. Although the covering member 76 comprises the long end open hollow cylinder in this embodiment, both ends of the hollow cylinder may be closed with lids. With this, the both ends of the covering member 76 are reinforced by the lids, and it is possible to reliably prevent the covering member 76 from being deformed.

1. A punching apparatus comprising:
a punching station A for punching a large number of sheet products 90 by a punching die 20 from a long material sheet 1 which is transferred in a horizontal direction; and
a take-out station B for taking out the sheet product 90 punched by said punching die 20,
said punching die 20 having a structure that a blade portion 202a of a tip end peripheral edge of a vertically penetrating die hole 28 is brought into contact with said material sheet 1 under pressure, thereby sequentially punching the sheet products 90 from the material sheet 1 and accommodating the sheet products 90 in said die hole 28 in a laminated state,
said take-out station B including an extrusion pusher 3 for pushing out said sheet products 90 which are accommodated in the laminated state from said die hole 28, wherein
said punching die 20 is disposed below a transfer region of said material sheet 1.

2. The punching apparatus according to claim 1, wherein in said punching station A, a pressing pusher 27 for pushing the punched sheet product 90 into said die hole 28 is provided at a position opposed to said punching die 20 from above.

3. The punching apparatus according to claim 1, wherein said punching die 20 is vertically driven by drive means.

4. The punching apparatus according to claim 2, wherein said punching die 20 is vertically driven by drive means.

5. The punching apparatus according to claim 1, further comprising: an air dancer mechanism for applying tension toward a downstream side of a long punching residue punched in said punching station A in the transfer direction; and a punching residue removing station D for reeling up said punching residue downstream of the air dancer mechanism, wherein
said air dancer mechanism includes: a vertical duct whose upper portion is opened for accommodating a U-shaped curved region formed by hanging a portion of said long punching residue downward; a covering member which is in contact with an upper surface of said U-shaped curved region and which has such a size as to cover a punched hole of the sheet product 90 remaining in said punching residue; and a suction fan for downwardly sucking interior of said vertical duct.

6. A punching die for bringing a blade portion 202a of an upper end peripheral edge of a vertically penetrating die hole 28 into contact with a material sheet 1 under pressure, thereby punching a sheet product 90 from the material sheet 1 into said die hole 28, wherein
an inner periphery of said blade portion 202a is formed into a tapered surface whose diameter is increased upwardly.

7. A punching die for bringing a blade portion 202a of an upper end peripheral edge of a vertically penetrating die hole 28 into contact with a material sheet 1 under pressure, thereby punching a sheet product 90 from the material sheet 1 into said die hole 28, wherein
an inner peripheral wall of said die hole 28 is provided with a plurality of elastic projecting members at distances from one another in a circumferential direction, each elastic projecting member being engaged with a peripheral edge of said sheet product 90 from below.

8. A punching die for bringing a blade portion 202a of an upper end peripheral edge of a vertically penetrating die hole 28 into contact with a material sheet 1 under pressure, thereby punching a sheet product 90 from the material sheet 1 into said die hole 28, wherein
an inner peripheral wall of said die hole 28 is provided with a plurality of elastic projecting members at distances from one another in a vertical direction, each elastic projecting member being engaged with a peripheral edge of said sheet product 90 from below.

9. A punching die for bringing a blade portion 202a of an upper end peripheral edge of a vertically penetrating die hole 28 into contact with a material sheet 1 under pressure, thereby punching a sheet product 90 from the material sheet 1 into said die hole 28, wherein
an inner peripheral wall of said die hole 28 is provided with a plurality of elastic projecting members at distances from one another in a circumferential direction and a vertical direction, each elastic projecting member being engaged with a peripheral edge of said sheet product 90 from below.

10. The punching die according to claim 9, wherein
said elastic projecting members disposed at distances from one another in an axial direction are disposed on a base block 70 at distances from one another in the vertical direction, the base block 70 being fitted into a fitting groove which is formed in an inner peripheral wall of said die hole 28 and extends in the vertical direction.

11. The punching die according to claim 6, comprising: a cylindrical blade 202 whose inner periphery is said die hole 28; and a blade holder 201 for holding said cylindrical blade 202, wherein said blade holder 201 is formed with a through hole comprising a large-diameter hole 203 which is tightly fitted over said cylindrical blade 202 in a state in which a blade portion 202 of an upper end of the cylindrical blade 202 is exposed outside, and a small-diameter hole 204 which is coaxial with the large-diameter hole 203, and in a state in which said large-diameter hole 203 is tightly fitted over said cylindrical blade 202, a lower end of said cylindrical blade 202 abuts against a step at a boundary whose inner diameter is varied from said large-diameter hole 203 to said small-diameter hole 204.

12. The punching die according to claim 7, comprising: a cylindrical blade 202 whose inner periphery is said die hole 28; and a blade holder 201 for holding said cylindrical blade 202, wherein said blade holder 201 is formed with a through hole comprising a large-diameter hole 203 which is tightly fitted over said cylindrical blade 202 in a state in which a blade portion 202 of an upper end of the cylindrical blade 202 is exposed outside, and a small-diameter hole 204 which is coaxial with the large-diameter hole 203, and in a state in which said large-diameter hole 203 is tightly fitted over said cylindrical blade 202, a lower end of said cylindrical blade 202 abuts against a step at a boundary whose inner diameter is varied from said large-diameter hole 203 to said small-diameter hole 204.

13. The punching die according to claim 8, comprising: a cylindrical blade 202 whose inner periphery is said die hole 28; and a blade holder 201 for holding said cylindrical blade 202, wherein said blade holder 201 is formed with a through hole comprising a large-diameter hole 203 which is tightly fitted over said cylindrical blade 202 in a state in which a blade portion 202 of an upper end of the cylindrical blade 202 is exposed outside, and a small-diameter hole 204 which is coaxial with the large-diameter hole 203, and in a state in which said large-diameter hole 203 is tightly fitted over said cylindrical blade 202, a lower end of said cylindrical blade 202 abuts against a step at a boundary whose inner diameter is varied from said large-diameter hole 203 to said small-diameter hole 204.

14. The punching die according to claim 9, comprising: a cylindrical blade 202 whose inner periphery is said die hole 28; and a blade holder 201 for holding said cylindrical blade 202, wherein said blade holder 201 is formed with a through hole comprising a large-diameter hole 203 which is tightly fitted over said cylindrical blade 202 in a state in which a blade portion 202 of an upper end of the cylindrical blade 202 is exposed outside, and a small-diameter hole 204 which is coaxial with the large-diameter hole 203, and in a state in which said large-diameter hole 203 is tightly fitted over said cylindrical blade 202, a lower end of said cylindrical blade 202 abuts against a step at a boundary whose inner diameter is varied from said large-diameter hole 203 to said small-diameter hole 204.

15. The punching die according to claim 10, comprising: a cylindrical blade 202 whose inner periphery is said die hole 28; and a blade holder 201 for holding said cylindrical blade 202, wherein said blade holder 201 is formed with a through hole comprising a large-diameter hole 203 which is tightly fitted over said cylindrical blade 202 in a state in which a blade portion 202 of an upper end of the cylindrical blade 202 is exposed outside, and a small-diameter hole 204 which is coaxial with the large-diameter hole 203, and in a state in which said large-diameter hole 203 is tightly fitted over said cylindrical blade 202, a lower end of said cylindrical blade 202 abuts against a step at a boundary whose inner diameter is varied from said large-diameter hole 203 to said small-diameter hole 204.

16. The punching die according to claim 11, wherein said cylindrical blade 202 is a Thomson hollow blade.

17. The punching die according to claim 12, wherein said cylindrical blade 202 is a Thomson hollow blade.

18. The punching die according to claim 13, wherein said cylindrical blade 202 is a Thomson hollow blade.

19. The punching die according to claim 14, wherein said cylindrical blade 202 is a Thomson hollow blade.

20. The punching die according to claim 15, wherein said cylindrical blade 202 is a Thomson hollow blade.

21. The punching die according to claim 6, wherein said blade portion 202a of said punching die sandwiches said material sheet 1 in cooperation with an elastic annular blade receiver 206 under pressure, said blade receiver 206 being detachably attached to a fixing wall.
